(19) United States
(12) Patent Application Publication
(10) Pub. No.: US 2010/0114680 A1
(43) Pub. Date: May 6, 2010

(54) On-site barcode advertising

(76) Inventors: Ryan Steelberg, Irvine, CA (US); Chad Steelberg, Newport Beach, CA (US)

Correspondence Address: Thomas J. McWilliams, Esquire;Drinker Biddle & Reath LLP, One Logan Square, 18th & Cherry Streets, Philadelphia, PA, 19103-6996, US

(21) Appl. No.: 12/587,080

(22) Filed: Oct. 1, 2009

Related U.S. Application Data
(60) Provisional application No. 61/101,696, filed on Oct. 1, 2008.

(51) Int. Cl. G06Q 30/00; G06F 17/00

(52) U.S. Cl. 705/14.4; 235/375

(57) ABSTRACT

A display that may be actually or virtually presented at a televised event venue. The display including at least one advertisement, advertising to the in-person attendees at the televised event or virtually inserted into the televised event venue as if advertising to the in-person attendees at the televised event, and at least one identifying marker coupled to the at least one advertisement, wherein the at least one identifying marker is suitable to provide identification of the at least one advertisement when the at least one advertisement is included within the broadcast of the televised event.

### CROSS REFERENCE TO RELATED APPLICATIONS

The present application claims priority to U.S. Provisional Application No. 61/101,696 entitled “On-Site Barcode Advertising,” filed Oct. 1, 2008, the entire disclosure of which is incorporated by reference herein as if set forth in its entirety.

### BACKGROUND OF THE INVENTION

a. Field of the Invention

The instant invention relates to the field of identification and tracking, and, in particular, to identification and tracking of advertising and creatives, and more particularly to the identification and tracking of advertising and creatives that are secondary to a broadcast event.

b. Description of Related Art

A barcode is a machine-readable representation of information, often having dark ink on a light background to create high and low reflectance, which varied reflectance may be digitally converted to 1s and 0s. Originally, barcodes stored data in the widths and spacings of printed parallel lines, but today they also come in patterns of dots, concentric circles, and text codes hidden within images. Barcodes can be read by optical scanners called barcode readers, or scanned from an image by special software, for example. Barcodes are widely used to implement Auto ID Data Capture (AIDC) systems that improve the speed and accuracy of computer data entry, among myriad other uses.

With the advent, and widespread popularity, of high-definition television (HDTV), which is a digital television broadcasting system with higher resolution than traditional television systems (NTSC, SECAM, PAL), for both broadcasting and viewing, additional data is created. HDTV is typically digitally broadcast, in part because digital television (DTV) requires less bandwidth for transmission if sufficient video compression is used.

The additional data created through HDTV may provide usefulness in the advertising industry. Advertising is a form of communication for which the purpose is to inform potential customers about products and services and how to obtain and use them. Many advertisements are also designed to generate increased consumption of those products and services through the creation and reinforcement of brand image and brand loyalty. For these purposes, advertisements often contain both factual information and persuasive messages. Every major medium is used to deliver this information and these messages, including: television, radio, movies, magazines, newspapers, video games, the Internet and billboards.

Advertisements can also be seen on the seats of grocery carts, on the walls of an airport walkway, on the sides of buses, heard in telephone hold messages and over in-store public address systems. Advertisements are usually placed anywhere an audience can easily and/or frequently access the visuals and/or audio and/or print featuring the advertised product or service. Such advertising is often placed by an advertising agency on behalf of a company.

Mobile Billboards are flat-panel campaign units having the purpose is of carrying advertisements along dedicated routes selected by clients prior to the start of a campaign. Mobile Billboard companies do not typically carry third-party cargo or freight. Mobile displays are used for various situations in metropolitan areas throughout the world, including: target advertising, one day, and long term campaigns, conventions, sporting events, store openings or other similar promotional events, and big advertisements from smaller companies.

Commercial advertising media can include wall paintings, billboards, street furniture components, printed flyers and rack cards, radio, cinema and television ads, web banners, mobile telephone screens, shopping carts, web popups, skywriting, bus stop benches, human directional, magazines, newspapers, town criers, sides of buses or airplanes (“logojets”), taxicab doors, roof mounts and passenger screens, musical stage shows, subway platforms and trains, elastic bands on disposable diapers, stickers on apples in supermarkets, shopping cart handles, the opening section of streaming audio and video, posters, and the backs of event tickets and supermarket receipts. Any place an “identified” sponsor pays to deliver their message through a medium is advertising.

A way to measure advertising effectiveness is known as ad tracking. This advertising research methodology measures shifts in target market presumptively based upon perceptions about the brand and product or service. These shifts in perception are plotted against the consumers' levels of exposure to the company's advertisements and promotions. The purpose of ad tracking is generally to provide a measure of the combined effect of the media weight or spending level, the effectiveness of the media buy or targeting, and the quality of the advertising executions or creative.

Therefore a need exists for an system that enables tracking of advertising, and particularly advertising displayed at a broadcast event, to be identified and tracked according to the broadcast time the advertisement receives.

### BRIEF SUMMARY OF THE INVENTION

A display that may be actually or virtually presented at a televised event venue. The display including at least one advertisement, advertising to the in-person attendees at the televised event or virtually inserted into the televised event venue as if advertising to the in-person attendees at the televised event, and at least one identifying marker coupled to said at least one advertisement, wherein said at least one identifying marker is suitable to provide identification of said at least one advertisement when said at least one advertisement is included within the broadcast of the televised event.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts and in which:

FIG. 1 there is shown an advertisement with a traceable mark according to an aspect of the present invention;

FIG. 2 there is shown a depiction of the traceable advertising system of the present invention;

FIG. 3 there is shown an on-site venue ad serving system according to an aspect of the present invention.

FIG. 4 there is shown a brand affinity software engine according to an aspect of the present invention which may utilize advertisements according to those of FIGS. 1-3;

FIG. 5 there is shown a methodology of assigning valuations according to an aspect of the present invention; and,

FIG. 6 there is shown a search aspect of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical object identification, advertising and tracking systems. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

High-definition television (HDTV) is a digital television broadcasting system with higher resolution than traditional television systems (NTSC, SECAM, PAL). HDTV broadcast systems are defined threefold, by the scanning methodology, lines of vertical resolution, and frame rate.

The scanning system of an HDTV typically employs one of a progressive scanning (p) or an interlaced scanning (i). Progressive scanning simply draws a complete image frame (all the lines) per image refresh, whereas interlaced scanning draws a partial image field (every second line) during a first pass, then fills-in the remaining lines during a second pass, per image refresh. Interlaced scanning requires significantly lower signal/data bandwidth, but an interlaced signal loses half of the vertical resolution and suffers “combing” artifacts when showing a moving subject on a progressive display (although the worst effects can be mitigated by suitable image post-processing known as ‘deinterlacing’). To compensate, however, interlaced mode provides finer time-sampling, giving two (half-resolution) image samples in the same time interval as one (full-resolution) image sample in progressive mode.

The 720p60 format is 1280×720 pixels progressive scanning with 60 fields per second (120 Hz). The 1080i50 format is 1920×1080 pixels (i.e. 2 MP) interlaced scanning with 50 fields per second. Sometimes interlaced fields are called half-frames, but they are not, because two fields of one frame are temporally shifted. Frame pulldown and segmented frames are special techniques that allow transmitting full frames via an interlaced video stream.

For commercial naming of the product, either the frame rate or the field rate is often dropped, e.g. a “1080i television set” label indicates only the image resolution. Often, the rate is inferred from the context, usually assumed to be either 50 or 60 Hz, except for 1080p, which denotes 1080p24, 1080p25, and 1080p30, but may include 1080p50 and 1080p60 in the future.

A frame or field rate can also be specified without a resolution. For example 24p means 24 progressive scan frames per second, and 50i means 25 interlaced frames per second consisting of 50 interlaced fields per second. Most HDTV systems support some standard resolutions and frame or field rates. The capability to determine that the marker is in the frame may be dependent on the resolution of the underlying broadcast, that is, the underlying broadcast may or may not be in high definition.

Data that is of sufficient quality for HDTV, or another high definition medium, may be analyzed for evidence of a marker according to an aspect of the present invention. In particular, this analysis may take place using the display medium of a television or may occur directly on the underlying data itself, or a combination of the data and the broadcast may be used. In order to reduce the level of computation involved, it may be possible to search the data or display for some hallmark of a marker, and then once that artifact is detected analyze the data or display further to determine the identity of the marker, or match the marker to an advertisement, and/or determine the time length of display and viewership factor of the medium.

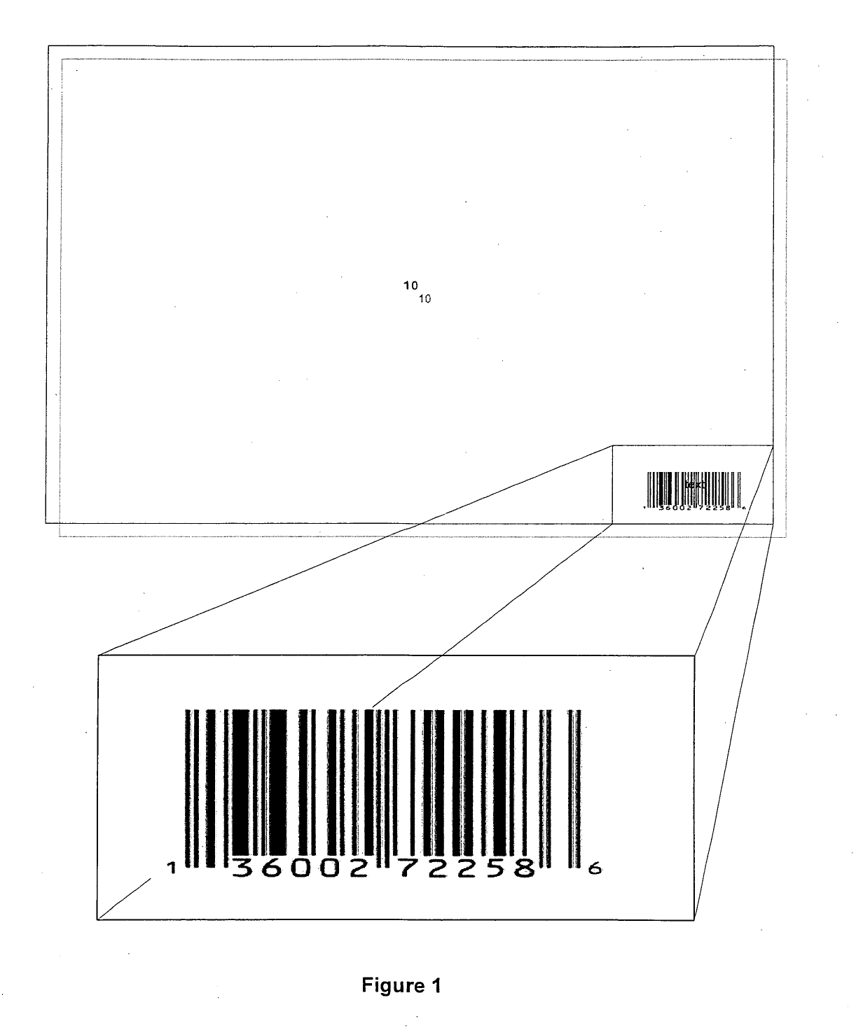

Referring now to FIG. 1, there is shown an advertisement or similar creative (hereinafter collectively referred to as “advertisement”) with a traceable mark according to an aspect of the present invention. As may be seen in FIG. 1, the advertisement 10 may include the traceable mark 20.

Advertisement 10 may take the form of an advertisement as discussed herein throughout. By way of a specific example, advertisement 10 may take the form of a billboard that may be displayed at a sporting event or at a stadium. Of course, such a billboard is exemplary only, and those skilled in the art will appreciate that any advertisement that may be displayed and additionally have included therewith a traceable mark 20 may be utilized according to the present invention. Such advertising forms that would be evident to those possessing an ordinary skill in the pertinent arts might include, for example, banners, large electronic displays, and the like.

Traceable mark 20 may, in fact, be any type of mark that would be traceable according to aspects of the present invention. Specifically, traceable mark may take the form of a barcode or watermark, for example. As discussed hereinabove, a barcode may be a computer and/or machine-readable representation of information (such as dark ink on a light background to create high and low reflectance which is converted to 1s and 0s), and/or a human readable mark. Barcodes may be stored data in the widths and spacing of printed parallel lines, and also may be constituted of patterns of dots, concentric circles, or text codes hidden within images.

Mapping between messages, barcodes and like traceable elements may be performed, and is herein referred to as symbology. A symbology includes the encoding of the single digits/characters of a message, as well as the start and stop markers of a message, into bars and space, generally with a quiet zone required to be before and after the barcode as well as the computation of a checksum.

Linear symbologies can be classified mainly by two properties, namely continuous versus discrete, and two width versus many width. Characters in continuous symbologies usually abut, with one character ending with a space and the next beginning with a bar, or vice versa. Characters in discrete symbologies begin and end with bars and the intercharacter space is ignored, as long as it is not wide enough to look like the code ends.

Bars and spaces in two-width symbologies are wide or narrow, although how wide a wide bar is exactly has no significance as long as the symbology requirements for wide bars are adhered to (usually two to three times more wide than a narrow bar). Bars and spaces in many-width symbologies are all multiples of a basic width called the module; with such codes typically using four widths of 1, 2, 3 and 4 modules.

Symbologies may use interleaving. The first character may be encoded using black bars of varying width. The second character may then be encoded, by varying the width of the white spaces between these bars. Thus characters may be encoded in pairs over the same section of the barcode, interleaved 2 of 5, for example.

Stacked symbologies may include a given linear symbology repeated vertically in multiple. There may also be 2-D symbologies which include matrix codes featuring square or dot-shaped modules arranged on a grid pattern. 2-D symbologies also come in a variety of other visual formats. Aside from circular patterns, there are several 2-D symbologies which employ steganography by hiding an array of different-sized or -shaped modules within a user-specified image, dataglyphs, for example.

In accordance with the present invention, barcode may be matched to a given advertisement such that the discovery of that barcode in a data stream or display corresponds to the given advertisement having been displayed or streamed. Alternatively, the barcode may have encoded information that, upon discovery of the barcode in a data stream or display, may be decoded concurrently or in later processing to determine the advertisement that was present in the data stream or display. Under a matched case scenario, after discovery of the barcode in the display or data stream, a conversion from the barcode to the advertisement may be performed, in part to determine the timing of the advertisement in the display or data stream. Under an encoding scenario, the bar code may be encoded with information to provide inventory type information and further enable high level scan information. Such high level information may identify the advertisement as Coke, for example, but not necessarily identify the particular advertisement itself. This would allow Coke to determine the overall coverage and presentation of its products and advertising without actually determining the particulars of the advertisements that were displayed or streamed. Such particular information may, however, be determined through further analysis using the information encoded via the present invention.

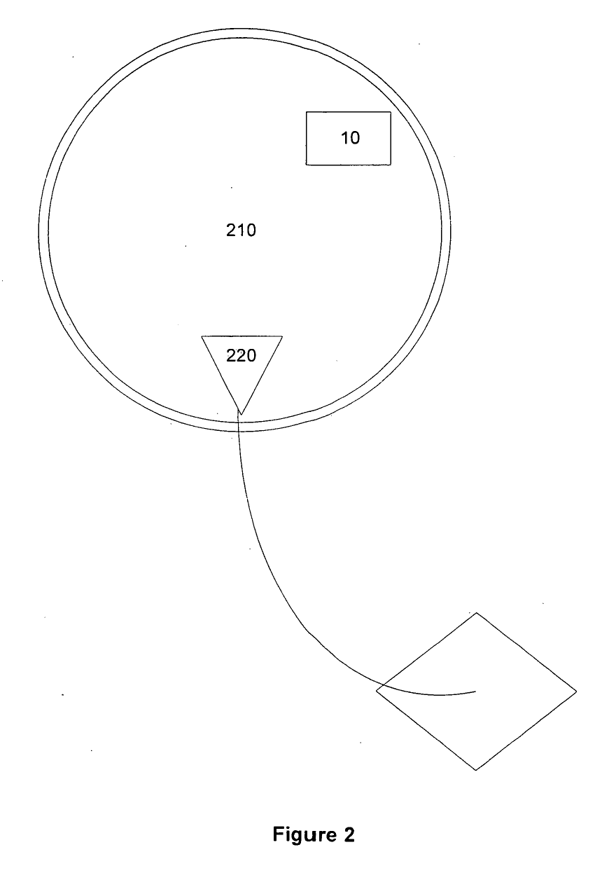

Referring now additionally to FIG. 2, there is depicted a system of the present invention. As may be seen in FIG. 2, a venue 210 containing an advertisement 10 that contains, or has imprinted thereon, a traceable marker 20, may be recorded using a transformer 220, thereby transforming the image, sound or other rendition of advertisement 10 and marker 20 into another medium, such a electromagnetic waves or a data format, for example. Needless to say, the marker may lend itself to providing varied data if the marker is transformatively displayed off angle or partially, or the like. For example, the marker may include keys that are read to assess how much of the marker, or advertisement, is displayed, as discussed herein throughout, and/or may be or aspects, such as colors, holograms, or angular antennae or receivers that may indicate the angle of view of the transformative broadcasting agent.

In the example of a billboard at a live sporting event, a high definition camera system may be used as the transformer 220. Such a camera system may digitize the image of the stadium, either during the underlying sports action such that a digital signal containing this information may be transmitted or broadcast to a viewing audience, or upon placement of the advertisement for conversion to stored data confirming the static presence of the advertisement in the location.

In a broadcast situation, the viewing audience may view the billboard advertisement that was displayed at the venue and was captured by the high definition camera system. Having a marker associated with the advertisement may create the ability to monitor the transmission of the event for the appearance of such marker, and to identify the timing of the presentation of the marker to thereby determine the amount of time the associated advertisement was displayed during the broadcast. From this timing information and the associated viewing audience information, such as the Nielson ratings discussed herein below, a numerical value may be associated with the viewership of the venue display advertisement.

In a static situation, storage of data, such as pictorial data in, for example, a database such as the vault discussed hereinbelow, allows for confirmation that a static ad has been placed. Further, the association of that data via the marker allows for electronic confirmation that the correct ad is in the correct physical location. Thereafter, with knowledge of the foot traffic in the placed venue, a numerical value may be associated with viewership of the subject ad. Thus, advertising within a venue, either analog or digital, may have associated therewith an “ad tag”, which may indicate a size and location of an ad just as an online ad tag does.

Using a sporting event broadcast example, and based on the effect that a television commercial has during, for example, the Super Bowl, it may be readily apparent the need to track the display of billboard advertising within the Super Bowl broadcast. In this regard, a television commercial is generally considered the most effective mass-market advertising format, as reflected by the high prices TV networks charge for commercial airtime during popular TV events. The annual Super Bowl football game in the United States is known as the most prominent television commercial advertising event on television. The average cost of a single thirty-second TV spot during this game has reached $2.7 million (as of 2007). However, advertising displayed at the Super Bowl venue, and thereby likely shown on the Super Bowl broadcast, particularly in the high definition version of that broadcast, may be obtained at a very significantly lower rate than the advertising rates for a 30 second TV spot, for example.

Virtual advertisements additionally may be inserted into regular television programming through computer graphics. Such virtual ads are typically inserted into otherwise blank backdrops or used to replace local billboards that are not relevant to the remote broadcast audience. Virtual billboards may be inserted into the background where none actually, physically exist on site. Virtual product placement is also possible. Such virtual advertisements have been commonly found in basketball broadcasts, wherein logos are been virtually displayed just beyond the three-point lines, for example. In baseball, such virtual advertisements have been found on the walls behind home plate and the batter, for example. In such situations, the advertisements may be manipulated such that a scrolling or changing display may be used—either in a real-time display or virtually. Such advertisements may, needless to say, be traceably marked for tracking as discussed herein.

Advertising on the World Wide Web is a recent phenomenon. Prices of Web-based advertising space are often dependent on the “relevance” of the surrounding web content and the traffic that the website receives. E-mail advertising is another recent phenomenon. Unsolicited bulk E-mail advertising is known as “spam”. Interstitial advertisement is a form of advertisement which takes place while a web page loads. Controversy exists on the effectiveness of subliminal advertising, and the persuasiveness of mass messages.

The mobile phone became a new mass media in 1998, when the first paid downloadable content appeared on mobile phones in Finland. It was only a matter of time until mobile advertising followed, also first launched in Finland in 2000. Mobile devices may, in the future, be available with high definition displays as well.

One type of mobile ad is based on SMS (Short Message Service) text messages. SMS has become the largest data application on the planet with over 2.4 billion active users. The addition of a text-back number is gaining prevalence as quickly as the “www” address had previously. The benefit of SMS text messages is people can respond immediately wherever they are, right now, even if stuck in traffic or sitting on a metro. The use of SMS text messages can also help get a viral (word-of-mouth) campaign off the ground, such as to build a database of sales prospects.

More advanced mobile ads include banner ads, coupons, MMS picture and video messages, advergames and various engagement marketing campaigns. A particular feature driving mobile ads is the 2D Barcode, which replaces the need to do any typing of web addresses, and uses the camera feature of modern phones to gain immediate access to web content. Needless to say, a 2D Barcode may serve as a traceable mark as discussed herein.

The most common method for measuring the impact of mass media advertising is the use of the rating point (rp), or the more accurate target rating point (trp). These two measures refer to the percentage of the universe of an existing base of audience members that can be reached by the use of each media outlet in a particular moment in time. The difference between the two is that the rating point refers to the percentage of the entire universe, while the target rating point refers to the percentage of a particular segment or target. This becomes very useful when focusing advertising efforts on a particular group of people. One of the reasons advertising is successful is because it can target a particular audience to build awareness of what the advertiser has to offer.

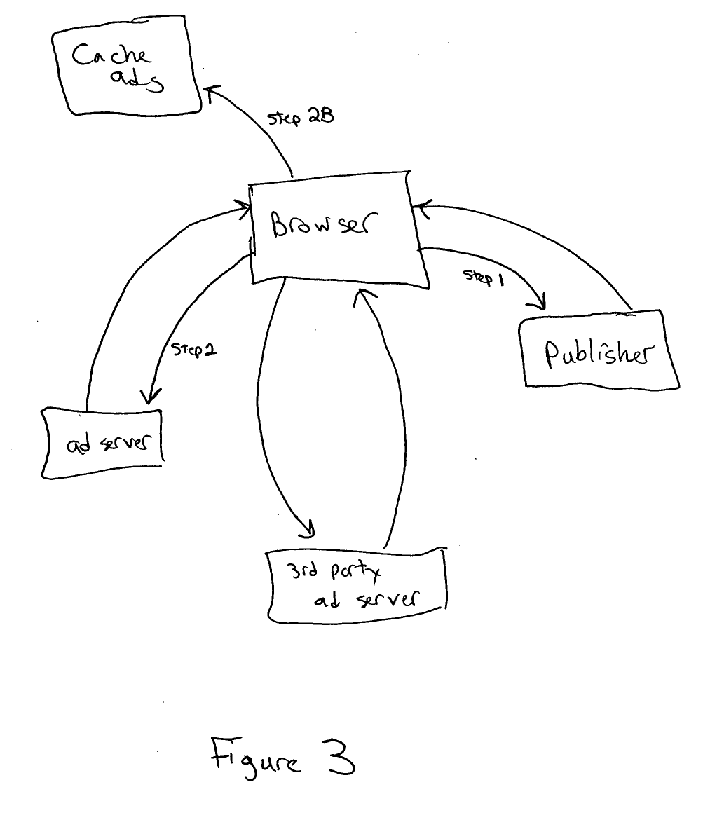

Returning now to FIG. 1, and as referenced hereinabove, barcode advertising may also be used as part of a feedback loop for advertising within an on-site venue. Referring now to FIG. 3, there is shown an on-site venue ad serving system according to an aspect of the present invention. As may be seen in FIG. 3, there is a browser coupled to a publisher via step 1, coupled to an ad server via step 2, coupled to a cache of ads via step 2B, and coupled to a 3rd party ad server via step 3.

To provide a coupling between the browser and the publisher, discussed as Step 1, the system of the present invention may request or allow for the request of an advertisement with a tag. This publisher may be an entity within the network of the present invention, and may be filling a request for an advertisement placement at an on-site venue, for example. The publisher may take the form of an owner of a venue seeking advertisement, a team or performer that occupies a given venue seeking to increase revenues, an advertising agency representing a party responsible for filling ad space within the venue, or the ad placement brand affinity engine of the present invention as discussed hereinbelow, by way of non-limiting example only.

Referring now specifically to the coupling between the browser and the ad server, step 2, the browser, responsive to the request for an advertisement with a traceable mark, or “tag”, from the publisher, queries the ad server to determine what ad matches the ad tag. After determining an ad that matches the requested ad, the ad server may deliver to the browser the ad that should be selectively placed. This may occur in an automated sense, and the delivery may take the form of immediate ad delivery via an online server, for example. This delivery may also take the form of an ad server requesting delivery from a photo/ad processor, such that the photo/ad processor prints the advertisement and delivers the ad for use in the placement selected. The printing may include defining the final necessitated size required, or color schema, such as by selecting the appropriate athlete or celebrity for endorsement, or venue or location with a venue, as defined in the present invention.

In accordance with Step 2B, the coupling between the browser and the cache of ads may allow for acquisition of the advertisement. Step 2B may form part of, or be separate from, Step 2. The cache of ads may be included within a ad server, for example. The cache of ads may be uniquely placed with respect to the ad server, thereby making Step 2B unique from Step 2, for example.

The present system may also utilize Step 3, wherein a 3rd party ad server is utilized. In such a situation, the ad may be acquired from an advertiser, for example.

By way of non-limiting example only, if a venue such as Yankee Stadium needs to fill a billboard advertisement, the system of the present invention may be employed. In such a scenario, a representative from Yankee Stadium may, such as from an advertising publisher of the present invention, request an ad with a tag. The browser of the present invention may, after determining the making of the request, query an ad server to determine an ad that matches the ad request. Then, information may, if necessary, be sent to a third party to deliver the appropriate ad, with an appropriate traceable mark, or “tag”, to Yankee Stadium. When the ad is delivered and placed within Yankee Stadium at the appropriate place, a picture may be taken and scanned into the system of the present invention, in order to provide feedback that the proper ad has been properly placed, such as to allow for a request for payment from the advertiser, for example. Thus, tagging may provide data to allow for confirmation of the placement of the advertisement in Yankee Stadium, the position of the advertisement within Yankee Stadium, details of the advertisement itself, or even before placement to confirm proper placement, such as via an audit functionality and may be a bar code according to an aspect of the present invention, for example.

Similarly, an advertiser may make a request that a creative be placed at any one or more of a plurality of available physical locations. In such a case, the request may be made electronically, and the process above may then continue as discussed above at the request to the third party to generate the physical ad with a tag, or the advertiser may generate the physical ad, for example.

In the case of digital display linked to a server within the venue of choice, the present invention may deliver the appropriate advertisement instead of a printed form as discussed hereinabove, such as a digital deliverable with the information, including the tag, necessary to place and confirm the ad. In such a situation, the browser of FIG. 3 may receive the digital ad from the ad server with the information regarding placement of same. This browser may then deliver the ad to the appropriate digital display in the appropriate physical location at the appropriate time frame.

According to an aspect of the present invention, a number of displays may be recorded. Further, the amount of time displayed may be recorded. Such recordation may be important, such as to allow for the calculation of the number of impressions of an advertisement that were made, such as in a stadium where the advertisement is next to a bathroom entrance and the stadium has determined that 10,000 people enter the restroom during a given event. The number of impressions of the displayed advertisement would be somewhere near 10,000 in such a situation, for example.

In the case of a static advertisement, the system of the present invention may operate as described above. The static advertisement may experience a delay from the time of advertisement selection, due in part to printing and time to physically place the advertisement within the venue, for example. Such an amount of time may be four days, for example. Such a placement may take the form of physical or electronic delivery in venue according to an aspect of the present invention. When the static advertisement is placed within the venue the advertisement may be recorded or recorded to data, such as by being photographed, and the photograph may be returned, such as electronically, into the system of the present invention. By querying traceable markings, such as a bar code located at the placement of the static advertisement and/or the bar code located on the advertisement itself, the ad server of the present invention may be able to confirm the placement of the advertisement.

The present invention may also track televised views of in-stadium ads and in stadium views, for example. The feedback loop on the placed in venue advertisements may also provide a URL view to the real time physical display, for example. Thereby, the present system may track live advertisements at a physical location not presently tracked or tracked efficiently, such as in suites at venues.

The present invention may additionally include a networked, communicatively interconnected system and method of delivering an advertisement of the present invention. According to an aspect of the present invention, a platform or engine may be provided to allow for the obtaining of an ad, an endorsement, or endorsed ad, in any of the aforementioned circumstances, either from a specific individual, a specific entity, a brand, a marketing partner, or a sponsor, for example. The development of a well targeted advertisement involves a dynamic interrelationship between all relevant factors, such as, for example, the goods or services, the prospective purchasers, any endorsing personalities and their agents, and the existing or upcoming media associated with each. The ideal advertisement engine thus must be able to harness and manage all aspects of each of these factors, based upon only a limited number of parameters from which to initiate and generate an advertisement.

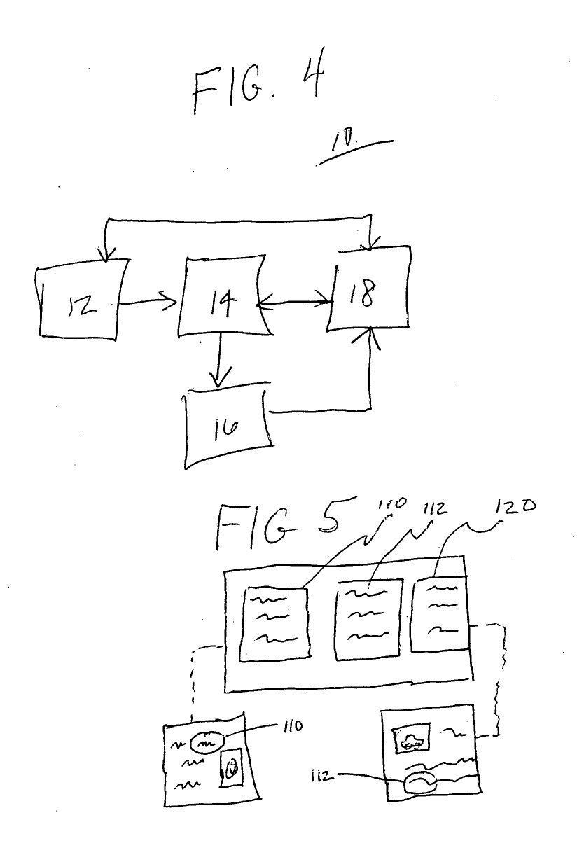

As illustrated in FIG. 4, the brand affinity software engine 10 of the present invention may provide a recommendation engine 12, a creative engine 14, a fulfillment engine 16, and a management engine 18. Those skilled in the art will appreciate that, although these engines are illustrated collectively in FIG. 4, that the present invention additionally contemplates the use of each of these engines discretely from the remaining illustrated engines. In this exemplary embodiment, the recommendation engine may, based on any number of known or assessed factors, recommend, for example, an ad for a certain venue or a sponsorship brand for use at certain times, in certain geographies, or with regard to certain products or services. The recommendation engine may generate recommendation metrics, and/or may issue scores, rankings, or the like. The creative engine may provide one or more templates for the creation of advertisements, and may additionally provide content, such as from a content “vault” that includes content of a variety of media formats, a variety of existing ads, or to a myriad of sponsors, for inclusion in a creative generated using the advertising template. For example, such content may include text, such as quotes, audio, video, pictures, highlights, or the like, and such content may have limited availability categorized by time, location, product, service, or the like. The fulfillment engine of the present invention, also referred to herein as an ad server, may, based on direct or redirect advertising delivery, deliver advertisements created, such as from the creative engine. It almost goes without saying that advertisements created for fulfillment using other advertising creation engines may likewise be incorporated into the fulfillment engine of the present invention for delivery in the present invention. Finally, the management engine of the present invention provides for tracking and reporting, as well as feedback for improved metrics and confirmations as discussed hereinabove, of the advertisements placed using the present invention.

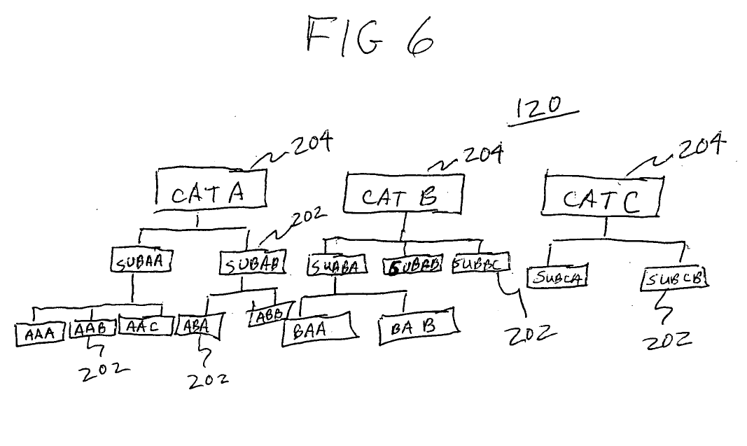

As referenced hereinabove, the recommendation engine may provide brand metrics for sponsoring brands or available ads, and the management engine may provide feedback with regard to modifying or improving brand metrics, profitability of available ad locations, and the like. Such improvements may be gauged in any number of ways, certain of which will be apparent to those skilled in the art in light of the disclosure herein. For example, as illustrated in FIG. 5, positive 110 and negative 112 mentions of sponsoring brands 114 may be tracked, such as by comparison of those brands with predetermined sets and/or subsets of “good” and “bad” keywords 120 for association with those sponsoring brands. Thereby, valuation may be assigned to certain keywords in the present invention, and thus the value of certain brands may be tracked, based on association with those keywords, over time, in certain geographies, in certain markets, and/or with regard to certain products or services, and the like. Keywords may, of course, be “good” to be associated with, meaning such keywords are indicative of positive associations with the sponsoring brand, “bad” to be associated with, meaning such keywords are indicative of negative associations with the sponsoring brand, or “neutral.”

Such keywords may be hierarchically organized as illustrated in FIG. 6, such that searches are performed only on certain categorically matched subsets 202 of such keywords 120 for sponsoring brands falling in particular categories 204. Needless to say, all keywords may be run against all brands, rather than employing the aforementioned hierarchal setup, and/or certain sponsoring brands may be associated with multiple subsets of keywords simultaneously based on their presence in multiple categories of sponsoring brands. Further, of course, keywords may thus be searched to locate acceptable advertisers seeking to place ads in a venue, or may be searched to assess metrics, such as foot traffic, in order to select a venue at which an ad is to be requested for placement.

Needless to say, the attributes and/or keywords reviewed for association with particular brands or sponsoring brands may vary by industry, such that the present invention may be used to generate side-by-side comparisons versus competitors by time, geography, product, or the like. For example, in the pharmaceutical industry, a particular brand name may be searched for associations, such as versus a generic equivalent, using keywords such as “side effect,” “health benefit,” “cost effective,” and the like. Such a search may be performed by time, by geography, or the like. For example, if a brand name manufacturer of a high blood pressure drug suddenly sees a dip in its rating too, for example, a −700 versus competing generics in a certain geographic region, such as the northwestern United States, it becomes obvious that that particular brand name must assess what sort of news has broken in the northwestern United States to negatively affect the brand versus the generic, and/or must change or improve their marketing program in some way in the northwestern United States. Likewise, a venue may refuse to advertise a pharmaceutical having an unreasonably high association with the keywords “side effect” or “deaths”.

Similarly, the present invention may be used as a tool for marketing projections over time. It almost goes without saying that the most positive effect an advertising tool can have is to predict who the next big sponsoring brand or advertiser will be in a particular market or in a particular locale, for example. For example, it may be that certain events on the PGA tour in certain locales create particularly positive “buzz” for certain players on the PGA tour in those areas. Such an outcome would not be surprising, because, of course, as the PGA tour moves to different events, the media moves with the touring professionals, and thus the qualitative and quantitative mentions of those touring professionals will increase with the movement of the tour, that is, will increase in the locales of the next tour events. However, this may not be the case for every tour event, such as the minor tour events, or it may not be the case for every touring professional in every locale. For example, foreign touring professionals may not experience increased buzz in certain locales, such as in the deep southern United States.

The present invention, nonetheless, can predict, in the aforementioned example, what PGA tour event, in what city, will affect, or most positively affect, what touring professional or professionals. Thereby, for example, venues may be able to raise prices for in-situ ad placement when a PGA Tour event is coming to town. Thus, the present invention may be used as a predictive tool. The present invention may, of course, additionally make use of historical data on the “buzz”, such as that associated with a certain tour event in a certain locale, to further refine the predictive capabilities of the present invention.

Of course, because the present invention connects metrics of the recommendation engine to the generation of a creative in the creative engine, and subsequently to the fulfillment engine wherein a buy of available advertising space occurs for placement of the creative, the present invention allows for a connection of the purchase of available advertising space directly with the brand affinity metrics discussed hereinabove. More specifically, available advertising space may be purchased, for example, by a particular advertiser or for use with a particular sponsor in those geographies or those venues in which that advertisement will have the greatest impact. Additionally, this may occur, as discussed hereinabove, in a predictive manner, such as wherein advertising space may be purchased cheaply in advance of a particular occurrence, but when the event occurs, the use of that advertising space typically provides a maximized impact for the expense incurred in buying the available advertising space.

The presence of the management engine in the present invention allows for feedback with regard to the success and/or placement properly of advertisements placed by time, location, product, service, or the like. Further, such feedback may allow for the comparisons discussed herein throughout, such as comparison of a particular brand against a baseline “no brand”. Thus, positive effects may be tracked by sponsoring brand, product, service, market, time, venue, geography, or the like. It of course goes without saying that a portion of the feedback that the management engine may provide necessarily requires knowledge of the fact that the advertisement was properly placed, as discussed herein above, and such proper placement may be tracked by an advertiser or venue, either visually or via data, as also discussed hereinabove. From such initial feedback a second layer of feedback and positive effects may be determined.

As such, the present invention, although capable of measuring the value of a particular creative, product, or service, also provides a measurement of what, or who, can advertise or endorse a particular product or service in order to help sell that product or service at a particular time, to a particular market, or in a particular location at the best cost for a venue or an advertiser, or at an optimal cost for both.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

What is claimed is:

1. An advertising system for placement of an advertisement at a geographic location, comprising:
an advertisement creation engine for selection and generation of a tangibly embodied advertisement, the advertisement comprising creative content and at least one traceable marker;
a non-virtual placement of the advertisement at the geographic location correspondent to a scan of the traceable marker; and
a tracking engine that stores ones of the scans of the traceable marker, wherein an advertiser reviews said tracking engine to confirm the geographic location of the advertisement.

2. The system of claim 1, wherein the traceable marker is one selected from the group consisting of a barcode, photograph, watermark, trademark, symbology and text.

3. The system of claim 1, further comprising an advertising image library wherein the traceable marker consists of at least one portion of an image used in the at least one advertisement.

4. The system of claim 1, wherein the non-virtual placement of the at least one advertisement is on one selected from the group consisting of a billboard, a television, a person, a balloon, a blimp, a plane, a vehicle and sporting equipment.

5. The system of claim 1, wherein the non-virtual placement of the at least one advertisement is tracked at least monthly.

6. The system of claim 1, wherein the non-virtual placement of the at least one advertisement is tracked at least daily.

7. The system of claim 1, wherein ones of the scans further comprises at least one photograph of the non-virtual placement of the advertisement.

8. An method for placing an advertisement, comprising the steps of:
creating a tangibly embodied advertisement for selection, the advertisement comprising creative content and at least one traceable marker;
placing, in a non-virtual placement, the advertisement at the geographic location correspondent to a scan of the traceable marker; and
racking and storing ones of the scans of the traceable marker, wherein an advertiser reviews said tracking engine to confirm the geographic location of the advertisement.

9. The method of claim 8, wherein the traceable marker is one selected from the group consisting of a barcode, photograph, watermark, trademark, symbology and text.

10. The method of claim 8, further comprising an advertising image library wherein the traceable marker consists of at least one portion of an image used in the at least one advertisement.

11. The method of claim 8, wherein the non-virtual placement of the at least one advertisement is on one selected from the group consisting of a billboard, a television, a person, a balloon, a blimp, a plane, a vehicle and sporting equipment.

12. The method of claim 8, wherein the non-virtual placement of the at least one advertisement is tracked at least monthly.

13. The method of claim 8, wherein the non-virtual placement of the at least one advertisement is tracked at least daily.

14. The method of claim 8, wherein ones of the scans further comprises at least one photograph of the non-virtual placement of the advertisement.
